(19) United States
(12) Patent Application Publication
(10) Pub. No.: US 2015/0148453 A1
(43) Pub. Date: May 28, 2015

(54) HALOGEN-FREE EPOXY RESIN COMPOSITION FOR INTEGRATED CIRCUIT PACKAGING

(71) Applicants: ITEQ CORPORATION, Ping Chen (TW); ITEQ (DONGGUAN) CORPORATION, Dongguan City (CN)

(72) Inventors: Feng Tang, Dongguan City (CN); Quansheng Zhu, Dongguan City (CN); Tsung-Lieh Weng, Dongguan City (CN); Yongxin Jiang, Dongguan City (CN); Hailin Li, Dongguan City (CN); Faquan Tu, Dongguan City (CN)

(73) Assignees: ITEQ CORPORATION, Ping Chen City (TW); ITEQ (DONGGUAN) CORPORATION, Dongguan City (CN)

(21) Appl. No.: 14/088,421

(22) Filed: Nov. 24, 2013

(51) Int. Cl. C08L 85/02

(52) U.S. Cl. CPC C08L 85/02; C08L 2201/02; C08L 2201/08; C08L 2203/20; C08L 2205/03
USPC 523/466

(57) ABSTRACT

Disclosed is a halogen-free epoxy resin composition for integrated circuit packaging, and the resin composition includes a polyfunctional epoxy resin, a benzoxazine resin, a phosphorus-containing a curing agent, an inorganic filler, a curing accelerator and a solvent. The rigid and firm resins and inorganic filler contained in the composition provide a low coefficient of thermal expansion and a high heat resistance, so that laminates made of this composition are applicable for IC packaging substrates, and the laminates contain halogen-free compounds with a flame retardant rating of UL94-V0 grade.

### FIELD OF THE INVENTION

The present invention relates to a halogen-free high-frequency resin composition for integrated circuit packaging.

### BACKGROUND OF THE INVENTION

As digital technology advances, electronic products are generally developed with a light, thin, short and compact design and a high speed, and thus printed circuit boards (PCB) requires small and thin wire holes sizes and high precision and stable performance and low cost. Led by such trend, IC packaging technologies of the PCB also advance significantly from the conventional Plated Through Hole (PTH) Insertion by 1980's to the revolutionary Surface Mount Technology (SMT) from 1980 to 1993 and then to the present BGA, CSP and FC, and LGA becomes the main packaging method now. Since the packaging technology advances, the IC packaging substrates have increasingly higher requirements.

To satisfy the micro, high-density, and high-frequency technological requirements, the materials used for the IC substrate must have good heat resistance and low coefficient of thermal expansion. Since common FR-4 epoxy substrates have a high coefficient of thermal expansion and fail to satisfy the aforementioned requirements. Although special resins such as bismalimide-triazine (BT), polyphenylene ether (PPE) resin, and polytetrafluoroethylene (PTFE) resin have excellent coefficient of thermal expansion, yet the price much higher than the common substrate and the special manufacturing techniques restrict the development of the IC packaging significantly, so that it is an urgent need for related manufacturers to develop a low-cost IC packaging substrate for the market.

### SUMMARY OF THE INVENTION

In view of the aforementioned shortcomings of the prior art, it is a primary objective of the present invention to overcome the shortcomings by providing a halogen-free high-frequency resin composition for integrated circuit packaging, and using a copper clad laminate made of the composition to provide the features of low coefficient of thermal expansion, high heat resistance, low dielectric loss, high glass transition temperature, and good flame retardation.

To achieve the aforementioned objective, the present invention provides a halogen-free epoxy resin composition for integrated circuit packaging, comprising:

(a) a polyfunctional epoxy resin;

(b) a benzoxazine resin;

(c) a phosphorus-containing curing agent;

(d) an inorganic filler;

(e) a curing accelerator; and

(f) a silane coupling agent;

wherein, the compositions (a), (b) and (c) have a total weight calculated according to 100 parts by mass, and the polyfunctional epoxy resin (a) occupies 15˜45 parts by mass; the benzoxazine resin (b) occupies 8-29 parts by mass; the phosphorus-containing curing agent (c) occupies 30˜60 parts by mass; the inorganic filler (d) occupies 60%˜220% of the total weight of the compositions (a), (b) and (c); the curing accelerator (e) occupies 0.01˜1% of the total weight of the composition (a), (b) and (c); and the silane coupling agent (f) occupies 0.01˜1% of the total weight of the compositions (a), (b) and (c).

The benzoxazine is a phenolphthalein benzoxazine with the following molecular structural formula:

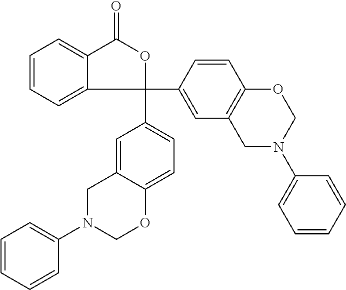 [SMILES: O=C1OC(c2ccc3c(c2)CN(c2ccccc2)CO3)(c2ccc3c(c2)CN(c2ccccc2)CO3)c2ccccc21]

The polyfunctional epoxy resin includes one or more epoxy resin selected from the group consisting of a trifunctional epoxy resin, a DCPD modified epoxy resin, a tetramethylbiphenyl epoxy resin, a biphenyl epoxy resin and a naphthalene ring epoxy with the following molecular structural formulas:

Trifunctional epoxy resin

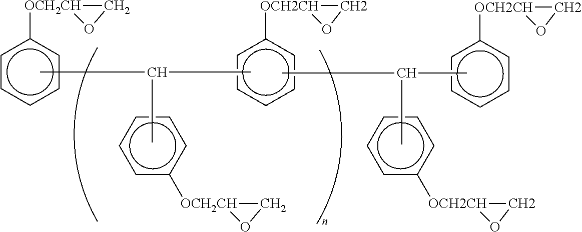

DCPD modified epoxy resin

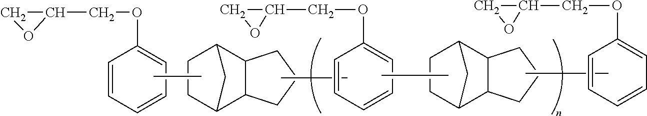

Tetramethylbiphenyl epoxy resin

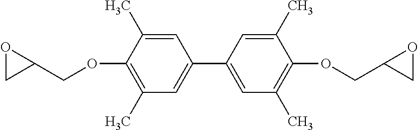 [SMILES: Cc1cc(-c2cc(C)c(OCC3CO3)c(C)c2)cc(C)c1OCC1CO1]

Biphenyl epoxy resin

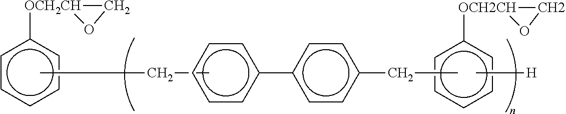

Naphthalene ring epoxy

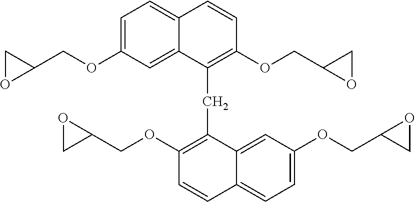 [SMILES: c1cc2ccc(OCC3CO3)c(Cc3c(OCC4CO4)ccc4ccc(OCC5CO5)cc34)c2cc1OCC1CO1]

The phosphorus-containing curing agent is a modified phenolic with a DOPO or DOPO derivative structure.

The inorganic filler includes one or more organic fillers selected from the group consisting of silica, spherical silica, silicon aluminate, kaolin and talcum powder.

The curing accelerator curing accelerator includes one or more imidazole curing accelerators selected from the group consisting of 2-methylimidazole, 2-ethyl-4-methylimidazole, 2-phenyl imidazole, and 2-undecylimidazole.

Compared with the prior art, the present invention has the following advantages and effects.

1. The composition of the present invention contains the benzoxazine resin with a rigid and heat-resisting phenolphthalein structure, while having a higher glass transition temperature than the common benzoxazine resin.

2. The composition of the present invention contains the polyfunctional epoxy resin with a naphthalene-ring or diphenyl rigid group structure capable of reducing the coefficient of thermal expansion of the rein positively, while providing good electric properties, high heat resistance, and high glass transition temperature.

3. The composition of the present invention contains the phosphorus-containing curing agent that provides good flame retardation, so that the flame is retardant capability of the compound can reach the Grade V0 standard.

4. The composition of the present invention contains the inorganic filler capable of reducing the coefficient of thermal expansion of the composition significantly, while lowering the cost and improving the flame retardation.

5. The copper clad laminates made of the composition is applicable for the packaging substrate and has the properties of low coefficient of thermal expansion, high heat resistance, high glass transition temperature (Tg), excellent flame retardation, and low dielectric loss.

### BRIEF DESCRIPTION OF THE DRAWINGS

None

### DESCRIPTION OF THE PREFERRED EMBODIMENTS

The aforementioned and other objectives and advantages of the present invention will become clearer in light of the following detailed description of an illustrative embodiment of this invention. It is intended that the embodiments disclosed herein are to be considered illustrative rather than restrictive.

A halogen-free epoxy resin composition for integrated circuit packaging comprises:

(A) an epoxy resin

A1: a naphthalene ring epoxy

A2: a tetramethylbiphenyl epoxy resin

A3: a trifunctional epoxy resin

A4: a BPA epoxy resin

(B) a thermosetting resin having a major composition of dihydrobenzoxazine compound.

B1: a phenolphthalein benzoxazine resin

B2: a BPA benzoxazine resin

(C) a phenolic resin

C1: a phosphorous-containing phenolic resin

C2: a linear phenolic resin

(D) an accelerant

D: Tetramethyl diethyl imidazole

(E) a coupling agent

E: a silane coupling agent

(F) an inorganic filler

F1: a melted silica

F2: a spherical silica

The aforementioned resins are melted and mixed according to the proportion given in Table 1, and then dipped and coated onto an enhance fiberglass fabric, and baked in an oven at 171° C. for 3-5 min. to obtain a prepreg, and a 1-oz copper foil is placed separately on both top and bottom surfaces of eight prepregs, and the prepregs are put into a laminating machine to produce laminates, and the properties of these laminates are evaluated.

TABLE 1
Recipes of the Composition (1) (parts by mass)

| | Embodiment | Embodiment | Embodiment | Embodiment | Embodiment | Embodiment | Embodiment | Control | Control | | |
|---|---|---|---|---|---|---|---|---|---|---|---|
| Code | 1 | 2 | 3 | 4 | 5 | 6 | 7 | 1 | 2 | Control 3 | Control 4 |
| A1 | 35 | 20 | 20 | 30 | 20 | 15 | 25 | | | 35 | |
| A2 | | 10 | | 10 | 5 | 5 | 10 | | | | |
| A3 | | | 15 | | 10 | | 5 | | | | |
| A4 | | | | | | | | 30 | 30 | | 35 |
| B1 | 20 | 20 | 10 | 25 | 25 | 29 | 20 | | | 20 | 25 |
| B2 | | | | | | | | 15 | 15 | | |
| C1 | 45 | 50 | 55 | 35 | 40 | 51 | 40 | 55 | 55 | 45 | 19 |
| C2 | | | | | | | | | | | 21 |
| D | 0.1 | 0.1 | 0.1 | 0.1 | 0.1 | 0.1 | 0.1 | 0.1 | 0.1 | 0.1 | 0.1 |
| E | 0.5 | 0.6 | 0.6 | 0.6 | 0.6 | 0.5 | 0.6 | 0.6 | 0.6 | 0.6 | 0.6 |
| F1 | 80 | 100 | 100 | 140 | 100 | 115 | 115 | 40 | 100 | 20 | 100 |
| F2 | 10 | 20 | 20 | 30 | 20 | 25 | 25 | 0 | 20 | 10 | 20 |

TABLE 2
Evaluation of Properties (1)

| | | | Embodiment | Embodiment | Example of | Example of | Example of | Example of |
|---|---|---|---|---|---|---|---|---|
| Condition | | Unit | 6 | 7 | Control 1 | Control 2 | Control 3 | Control 4 |
| Peeling strength (Hoz) | | lb/in | 7.1 | 7.1 | 6.9 | 7.3 | 7.2 | 7.1 |
| Water Absorption Rate | PCT121° C. * 1 hr | % | 0.43 | 0.43 | 0.54 | 0.48 | 0.48 | 0.48 |
| PCT(1 hr) + Dip | 288° C. | min | >10 | >10 | >10 | >10 | >10 | >10 |
| Float(Cu) | 288° C. | min | >10 | >10 | >10 | >10 | >10 | >10 |
| Tg | DSC | ° C. | 198 | 215 | 168 | 166 | 203 | 175 |
| | TMA | ° C. | 189 | 208 | 160 | 159 | 195 | 168 |
| T288 | Containing Copper | min | >60 | >60 | >60 | 30 | >60 | 10 |
| Df | 1G | | 0.009 | 0.009 | 0.016 | 0.011 | 0.012 | 0.009 |
| CTE (%) | TMA | % | 1.6 | 1.5 | 3.2 | 2.6 | 2.6 | 2.8 |
| flame retardant | UL94 | | V0 | V0 | V0 | V0 | V0 | V1 |

TABLE 3
Evaluation of Properties (2)

| | | | Embodiment | Embodiment | Example of | Example of | Example of | Example of |
|---|---|---|---|---|---|---|---|---|
| Condition | | Unit | 6 | 7 | Control 1 | Control 2 | Control 3 | Control 4 |
| Peeling strength (Hoz) | | lb/in | 7.1 | 7.1 | 6.9 | 7.3 | 7.2 | 7.1 |
| Water Absorption Rate | PCT121° C. * 1 hr | % | 0.43 | 0.43 | 0.54 | 0.48 | 0.48 | 0.48 |
| PCT(1 hr) + Dip | 288° C. | min | >10 | >10 | >10 | >10 | >10 | >10 |
| Float(Cu) | 288° C. | min | >10 | >10 | >10 | >10 | >10 | >10 |
| Tg | DSC | ° C. | 198 | 215 | 168 | 166 | 203 | 175 |
| | TMA | ° C. | 189 | 208 | 160 | 159 | 195 | 168 |
| T288 | Containing Copper | min | >60 | >60 | >60 | 30 | >60 | 10 |
| Df | 1G | | 0.009 | 0.009 | 0.016 | 0.011 | 0.012 | 0.009 |
| CTE (%) | TMA | % | 1.6 | 1.5 | 3.2 | 2.6 | 2.6 | 2.8 |
| flame retardant | UL94 | | V0 | V0 | V0 | V0 | V0 | V1 |

The testing methods of the aforementioned properties are described below:

(1) Water Absorption Rate: It is a percentage of the weight difference before and after the PCT steaming process with respect to the sample weight before the PCT takes place.

(2) Thermal layer division time: The delamination layer division time is recorded, after the PCT is steamed for an hour at 121° C. in 105 KPa pressure cooker, and dipped in the solder pot at 288° C.

(3) Copper clad floating solder Float (Cu): The delamination time is measured when the solder (at 288° C.) of a copper clad laminate floats on a solder pot.

(4) Thermal layer division time T-288: It is measured according to the IPC-TM-650 2.4.24.1 method.

(5) Coefficient of thermal expansion Z-axis CTE (TMA): It is measure according to the IPC-TM-650 2.4.24 method.

(6) Glass transition temperature (Tg): It is measured according to the differential scanning calorimetry (DSC) and the DSC method as set forth by the IPC-TM-6502.4.25 regulation.

(7) Dielectric Loss Tangent: It is measured below 1 GHz by a parallel board method according to the IPC-TM-6502.5.5.9 regulation.

(8) Combustibility: It is measured by a vertical combustion method according to the UL 94 regulation.

In summation, the halogen-free epoxy resin composition of the present invention applied in the IC packaging substrate contains no halogen, and the flame retardation reaches the UL94V-0 grade, and the copper clad laminate made of the composition and applied in the packaging substrate has the properties of very low coefficient of thermal expansion, high heat resistance, high glass transition temperature (Tg), excellent flame retardation and low dielectric loss.

While the invention has been described by means of specific embodiments, numerous modifications and variations could be made thereto by those skilled in the art without departing from the scope and spirit of the invention set forth in the claims.

What is claimed is:

1. A halogen-free epoxy resin composition for integrated circuit packaging, comprising:
(a) a polyfunctional epoxy resin;
(b) a benzoxazine resin;
(c) a phosphorus-containing curing agent;
(d) an inorganic filler;
(e) a curing accelerator;
(f) a silane coupling agent ;
wherein, the total weight of the compositions (a), (b) and (c) is calculated according to 100 parts by mass, and the polyfunctional epoxy resin (a) contains 15-45 parts by mass; the benzoxazine resin (b) contains 8-29 parts by mass; and
the phosphorus-containing curing agent (c) contains 30˜60 parts by mass;
the inorganic filler (d) occupies 60%˜220% of the total weight of the compositions (a), (b) and (c);
the curing accelerator (e) occupies includes 0.01˜1% of the total weight of the compositions (a), (b) and (c); and
the silane coupling agent (f) occupies 0.01˜1% of the total weight of the compositions (a), (b) and (c).

2. The halogen-free epoxy resin composition for integrated circuit packaging according to claim 1, wherein the benzoxazine resin is a phenolphthalein benzoxazine resin with the molecular structural formula:

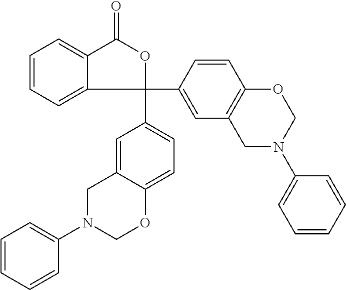 [SMILES: O=C1OC(c2ccc3c(c2)CN(c2ccccc2)CO3)(c2ccc3c(c2)CN(c2ccccc2)CO3)c2ccccc21]

3. The halogen-free epoxy resin composition for integrated circuit packaging according to claim 1, wherein the polyfunctional epoxy resin includes one or more epoxy resins selected from the group consisting of a trifunctional epoxy resin, a DCPD modified epoxy resin, a tetramethylbiphenyl epoxy resin, a biphenyl epoxy resin and a naphthalene ring epoxy, and the molecular structural formula of the trifunctional epoxy resin is 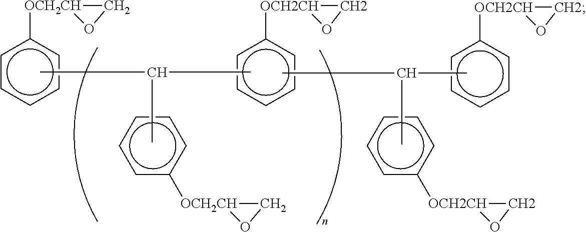
and the molecular structural formula of the DCPD modified epoxy resin is 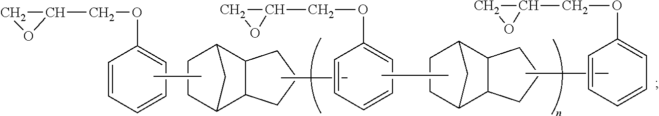
and the molecular structural formula of the tetramethylbiphenyl epoxy resin is 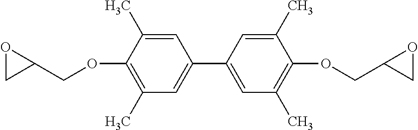 [SMILES: Cc1cc(-c2cc(C)c(OCC3CO3)c(C)c2)cc(C)c1OCC1CO1]
and the molecular structural formula of the biphenyl epoxy resin is 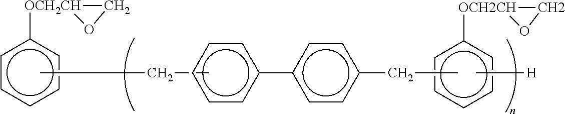
and the molecular structural formula of the naphthalene ring epoxy is

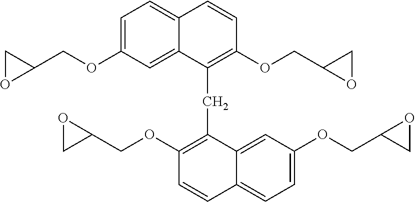 [SMILES: c1cc2ccc(OCC3CO3)c(Cc3c(OCC4CO4)ccc4ccc(OCC5CO5)cc34)c2cc1OCC1CO1]

4. The halogen-free epoxy resin composition for integrated circuit packaging according to claim 1, wherein the phosphorus-containing curing agent is a modified phenolic with a DOPO or DOPO derivative structure.

5. The halogen-free epoxy resin composition for integrated circuit packaging according to claim 1, wherein the inorganic filler includes one or more organic fillers selected from the group consisting of silica, spherical silica, silicon aluminate, kaolin and talcum powder.

6. The halogen-free epoxy resin composition for integrated circuit packaging according to claim 1, wherein the curing accelerator includes one or more imidazole curing accelerators selected from the group consisting of 2-methylimidazole, 2-ethyl-4-methylimidazole, 2-phenyl imidazole, and 2-undecylimidazole.
